(19) United States
(12) Patent Application Publication
(10) Pub. No.: US 2014/0072692 A1
(43) Pub. Date: Mar. 13, 2014

(54) GARLIC EGG YOLK COMPOSITION

(71) Applicants: Ichiro YAMADA, (US); SANJYO CO., LTD, Fukuoka (JP)

(72) Inventor: Ichiro Yamada, Fukuoka (JP)

(21) Appl. No.: 14/002,864

(22) PCT Filed: Oct. 30, 2012
(86) PCT No.: PCT/JP2012/077980

§ 371 Date: Sep. 3, 2013

(30) Foreign Application Priority Data
Jun. 7, 2012 (JP) 2012-130003

(51) Int. Cl. A23L 1/32

(52) U.S. Cl. CPC A23L 1/3212
USPC 426/614

(57) ABSTRACT

There is provided a garlic egg yolk composition in which the acrid taste and odor peculiar to garlic are suppressed even without using a special production device, chemicals, chemical additives and the like. A garlic egg yolk composition comprising a resveratrol-containing plant extract and garlic and egg yolk. The smell derived from garlic is suppressed due to the effect of a resveratrol-containing plant extract, but the nutritive values of garlic and egg yolk, and a resveratrol-containing plant extract are not lost. The resveratrol-containing plant extract is preferably at least one selected from grape extract, melinjo extract and Polygonum cuspidatum extract.

### CROSS-REFERENCE TO RELATED APPLICATION

The present application is based on International Application No. PCT/JP2012/077980 which was filed on Oct. 30, 2012, and claims priority under 35 U.S.C. §119 from Japanese Patent Application No. 2012-130003 which was filed on Jun. 7, 2012, the entire disclosure of which, including specification, claims, drawings and summary, is incorporated herein by reference in its entirety.

### BACKGROUND OF THE INVENTION

### Field of the Invention

The present invention relates to a garlic egg yolk composition and a method for producing the same.

### DESCRIPTION OF THE RELATED ART

### Background Art

A garlic egg yolk composition comprises garlic and egg yolk as main materials and is produced by heating and kneading these materials.

Recently, the garlic egg yolk composition has been commercially produced and sold as a dietary supplement which is easily taken. Since the garlic egg yolk composition has been commercially sold in large quantities, its appearance and smell are more problematic than ever before, and also the uniformity of quality is strictly required.

It often happens, however, that garlic egg yolk compositions are produced variable depending on color, tastes, fragrances and the like of completed products due to subtle differences in the compounding ratio of the materials garlic and egg yolk, the degree of oxidation and maturation of garlic, differences in the harvesting season and production area of garlic. To solve the variability, chemicals are frequently added thereto, such as a pH adjuster, a coloring agent, a seasoning agent and a stabilizer. It is not, however, desirable to add chemicals to a garlic egg yolk composition for consumers.

The garlic egg yolk composition also requires preparation of garlic and egg yolk, and heating over a long period of time and a frequent stirring operation in the production step. Commercial production, therefore, is mainly carried out in processing plants. Since large quantities of garlic are processed in a processing plant, strong garlic odor emission has become a problem in the production step.

As a method for suppressing garlic odor in the production step of a garlic egg yolk composition, Japanese Patent Document No. 4846879 discloses a production method in which raw garlic is heated with high temperature water vapor and stirred and smashed, and to this, egg yolk and water are added to obtain a slurry, and the slurry was then subjected to spray drying.

### SUMMARY OF THE INVENTION

According to the production method disclosed in Japanese Patent Document No. 4846879, garlic odor in the production step can be suppressed. In this production method, however, special devices, such as a high temperature water vapor exposure device and a spray dryer, are required. Further, since materials are exposed to high temperature water vapor at 100° C. or more, there are problems, such as denaturation of garlic ingredients, discoloration of completed products and significant decrease in the effect of active components contained in garlic.

In such circumstances, the present invention provides a garlic egg yolk composition in which the acrid taste and stink peculiar to garlic are suppressed, the active components of garlic are less deteriorated and the quality is high even without using a special production device and chemicals, and a method for producing the same.

As a result of repeated intensive investigation to solve the above problems, the present inventors found that the above problems were solved by using a resveratrol-containing plant extract, thereby reaching the present invention.

That is, the present invention relates to the following invention.

<1> A garlic egg yolk composition, comprising a resveratrol-containing plant extract, and garlic and egg yolk.

<2> The garlic egg yolk composition according to <1> above, containing from 10 parts by weight to 100 parts by weight inclusive of the plant extract relative to a total of 100 parts by weight of garlic and egg yolk.

<3> The garlic egg yolk composition according to <1> or <2> above, wherein the plant extract is grape extract.

<4> The garlic egg yolk composition according to <1> or <2> above, wherein the plant extract is melinjo extract.

<5> The garlic egg yolk composition according to <1> or <2> above, wherein the plant extract is Polygonum Cuspidatum extract.

<6> The garlic egg yolk composition according to any of <1> to <5> above, wherein the garlic and egg yolk are subjected to heat treatment.

<7> A method for producing a garlic egg yolk composition, the method comprising the steps of forming a clayey composition by heating and stirring garlic and egg yolk at 85° C. or less, and

kneading the clayey composition and a resveratrol-containing plant extract at 85° C. or less.

<8> A method for producing a garlic egg yolk composition, the method comprising the steps of homogenously dispersing garlic extract and egg yolk extract which are added to an edible oil, and

adding a resveratrol-containing plant extract to the edible oil, in which garlic and egg yolk are dispersed, and mixing the obtained oil.

According to the present invention, there is provided a garlic egg yolk composition in which the acrid taste and stink peculiar to garlic are suppressed, the original active components of garlic are less deteriorated, and the quality is high. In addition, according to the production method of the present invention, garlic odor in the production step is suppressed and the garlic egg yolk composition of the present invention can be stably produced even without using a special production device.

### DESCRIPTION OF THE EMBODIMENTS

The present invention relates to a garlic egg yolk composition comprising a resveratrol-containing extract, garlic and egg yolk.

The “garlic egg yolk composition” in the present invention means a composition comprising at least garlic and egg yolk, and other ingredients other than the above. The garlic egg yolk composition of the present invention includes both heated components and non-heated components, and among said components, at least garlic and egg yolk are preferably subjected to heat treatment.

The garlic egg yolk composition of the present invention comprises a resveratrol-containing plant extract as an ingredient other than garlic and egg yolk. Since the garlic egg yolk composition of the present invention comprises a resveratrol-containing plant extract, the acrid taste and stink peculiar to garlic can be suppressed. As described below, in the production step comprising heating, the acrid taste and stink peculiar to garlic can be suppressed by adding a resveratrol-containing plant extract.

Each ingredient contained in the garlic egg yolk composition of the present invention is described below.

(Resveratrol-Containing Plant Extract)

A resveratrol-containing plant extract may be an extract from a plant containing resveratrol. In addition, “resveratrol” in the present invention includes not only a monomer but also a resveratrol dimer (gnetin C).

The plant extract in the present invention is the overall concept of forms in which by e.g. compressing or solvent extraction of a target plant which is in the unprocessed state or is dried and heated as needed, the content of active components contained in the plant is increased.

That is, the plant extract in the present invention includes all of an extract liquid obtained from a target plant as a raw material, a dilute solution or concentrated solution of the extract liquid, a dry substance obtained by drying the extract liquid, or a roughly purified substance or purified substance of the above.

Examples of plants containing resveratrol include grapes, melinjos, Polygonum cuspidatums, peanuts, onions and the like. Among these, preferred are grapes, melinjos and Polygonum cuspidatums.

As grapes, the fruit peel of Vitaceae Vitis sp. plants can be suitably used, and those comprising the fruits, leaves, stems of grape or a mixture thereof along with grape peel may be used as materials of grape.

As the grape extract, an extract using a solvent from grape peel is preferred.

The extraction of grape extract from grape peel (may contain the fruits, leaves and stems of grape) can be carried out by a conventional method, and is not particularly limited.

As a suitable example, for a static immersion extraction method, grape peel and a solvent are sufficiently stirred and mixed with each other and then left to stand for a fixed period of time until an extract is sufficiently extracted in the solvent from grape peel. The standing time may be appropriately determined considering types of grape which is a material, a proportion thereof to a solvent and the like.

Examples of solvents used for extraction include water and alcohols such as ethanol, isopropanol and n-butanol. Preferred is an extract in which extraction is carried out with water and/or ethanol, more preferably ethanol which can contain approximately 10 to 50% by weight of water and then the solvent is removed.

As the grape extract, a commercially available product can be used, and a suitable example includes Product name: Resveratrol manufactured by JMC CO., LTD.

Melinjo (nomenclature: Gnetum gnemon) is a gymnosperm plant belonging to Gnetaceae. Melinjo seeds have high nutritive value and contain resveratrol dimer (gnetin C) in large amounts in addition to carbohydrates and proteins. Parts of plants used for extraction is not limited to fruits, seeds or leaves as long as each parts contain resveratrol, however seeds are preferred.

The extraction of melinjo extract from melinjo seeds (may contain the fruits, leaves and stems of melinjo) can be carried out by a conventional method, and is not particularly limited.

A suitable example may include a method in which the seeds of melinjo, which are crushed to an appropriate size, and an appropriate amount of dextrin are dispersed in purified water and the solvent is then distilled off and the residue is freeze-dried.

A suitable example of commercially available products of melinjo extract may include Product name: Melinjo Resveratrol-20 manufactured by the head office of Yamada Bee Farm Corporation.

Polygonum cuspidatum (nomenclature: Fallopia japonica) used in the present invention is a perennial belonging to Polygonaceae, and is preferably used because roots and stems thereof contain resveratrol in large amounts. Polygonum cuspidatum may be used raw, or one which is processed by drying and fermentation. Further, one obtained by processing such as cutting, pulverization and concentration according to conventional methods can be used.

The extraction of Polygonum cuspidatum extract can be carried out by conventional methods such as an extraction method using an organic solvent and water and a critical extraction method, and is not particularly limited. Extractants include preferably polar solvents, further preferably alcohols, water and liquefied carbon dioxide, and more preferably ethylalcohol, water and liquefied carbon dioxide. Polygonum cuspidatum may be further treated by e.g. concentration.

A suitable example of commercially available Polygonum cuspidatum extract can include Product name: Resveratrol manufactured by Everyday Wellness Corporation (USA).

(Garlic)

Garlic used in the present invention may be raw garlic, or garlic extract in which raw garlic is processed and treated.

Examples of process and treatment methods for garlic include liquefaction by trituration, pulverization after drying, and heating, and said methods may be combined. Two or more of these garlic having different states can be used in combination.

(Egg Yolk)

As egg yolk used in the present invention, the egg yolk of birds such as chicken, quail and ostrich can be used, and the egg yolk of chicken is preferably used. Two or more of the above may be used in combination. Egg yolk extract in which egg yolk is processed and treated may be used. Examples of egg yolk extract include egg yolk powder, sweetened egg yolk, salted egg yolk and the like. Two or more of the above may be used in combination.

(Compounding Ratio of Ingredients)

The compounding ratio of garlic and egg yolk in the composition of the present invention is not particularly limited, and is generally 5 to 100 parts by weight of egg yolk, preferably 5 to 30 parts by weight of egg yolk, to 100 parts by weight of garlic.

The compounding ratio of a resveratrol-containing plant extract contained in the garlic egg yolk composition of the present invention is determined within the range in which the acrid taste and stink peculiar to garlic are suppressed and further each active component of garlic, egg yolk and a resveratrol-containing plant extract effectively expresses the function thereof.

The suitable compounding ratio varies depending on types of resveratrol-containing plant extract, and when using grape peel extract or melinjo extract, it is preferred that from 10 parts by weight to 100 parts by weight inclusive of a resveratrol-containing plant extract to be contained relative to a total of 100 parts by weight of garlic and egg yolk.

(Other Ingredients)

The garlic egg yolk composition of the present invention may contain additives such as diluting agents, sweetening agents, acidulants, thickeners, perfumes, pigments or emulsifying agents as long as the object of the present invention is not impaired. The combination proportion of these optional ingredients can be appropriately determined depending on objects.

(Production Method of a Garlic Egg Yolk Composition)

Insofar as the garlic egg yolk composition of the present invention comprises garlic, egg yolk and a resveratrol-containing plant extract and the acrid taste and stink peculiar to garlic are suppressed as described above, the production method is not particularly limited, however, the production method described below (hereinafter, may be referred to as “the production method of the present invention”) is suitable.

In addition, garlic, egg yolk and a resveratrol-containing plant extract described in the production method of the present invention described below are as described above.

An embodiment of the production method of the present invention includes a method comprising the steps of forming a clayey composition by heating and stirring garlic and egg yolk at 85° C. or less (preferably 70° C. or less), and kneading the clayey composition and a resveratrol-containing plant extract at 85° C. or less (preferably 70° C. or less).

This production technique is an improved type of a conventional traditional production technique for a garlic egg yolk composition disclosed in e.g. Japanese Patent Document No. 4322103 B1.

By this production technique, a clayey garlic egg yolk composition is obtained. This can be directly used or can be changed to a form of e.g. powders, granules, tablets and pills by drying and shaping into a proper form as needed.

Although garlic is heated in this production method, the temperature at the time of heating and stirring is 85° C. or less, and thus the degeneration of garlic ingredients is less prone to occur. By setting the temperature at the time of heating and stirring to 70° C. or less, particularly, the degeneration of garlic ingredients hardly occurs, which is preferred.

When garlic and egg yolk are heated and stirred at 85° C. or less, garlic odor is emitted, however, by adding a resveratrol-containing plant extract thereto and kneading the obtained mixture, garlic odor significantly decreases.

The heating and stirring time in each step varies depending on e.g. a water amount contained in materials, and is generally for approximately 1 to 5 hours. The heating time is for approximately 2 to 10 hours in total.

Another embodiment of the production method of the present invention includes a method comprising the steps of homogenously dispersing garlic extract and egg yolk extract which are added to an edible oil, and adding a resveratrol-containing plant extract to the edible oil, in which garlic and egg yolk are dispersed, and mixing the obtained oil.

A garlic egg yolk composition in the form of liquid is obtained in this production technique, and put into e.g. a soft capsule and used as a capsule.

The method for dispersing materials is not particularly limited insofar as materials can be homogenously dispersed in each step, and a conventionally known dispersing method may be adopted.

Here, the garlic extract and egg yolk extract are obtained by processing raw garlic and raw egg yolk without losing active components. Examples of processing methods include a method for obtaining the liquid state by trituration, a method for pulverization after drying, a method for heating and the like. Examples of suitable garlic extract and egg yolk extract are dry garlic powder and dry egg yolk powder.

An edible oil in which garlic extract and egg yolk extract are dispersed is not particularly limited insofar as it is generally used as an edible oil, and examples thereof include rice bran oil, rapeseed oil, sesame oil, corn oil and the like.

The ratio of garlic extract and egg yolk extract and a resveratrol-containing plant extract which are added to an edible oil is not particularly limited within the range in which the object of the present invention can be achieved, and is generally approximately 10 to 100 parts by weight relative to 100 parts by weight of edible oil.

(Forms of a Garlic Egg Yolk Composition)

The garlic egg yolk composition of the present invention can be used as food, especially health food, functional food, dietary supplement and the like. In addition, the food related to the present invention may be produced in the forms of solutions, powders, granules, capsules, tablets and pills as a nutritional supplement.

An intake of the garlic egg yolk composition of the present invention is not particularly limited, and can be appropriately selected depending on the mixing ratio of garlic and egg yolk, the ratio of a resveratrol-containing plant extract relative to the total of garlic and egg yolk, dosage forms, and age, body weight and symptoms of the person who takes the composition.

### EXAMPLE

The present invention will be here described in more detail by way of examples thereof. It should be noted, however, that the present invention is not limited to the following examples unless the gist thereof is not changed.

The used materials are as follows.

(1) Grape extract

“Resveratrol” (Product name) manufactured by JMC Co., Ltd.

Extract (powder type) obtained by extraction from grape peel with hydrous ethanol and drying

Resveratrol content: 5% by weight or more (HPLC)

Grain size: 80 mesh

(2) Melinjo extract

“Melinjo Resveratrol-20” (Product name) manufactured by the head office of Yamada Bee Farm Corporation.

Materials: melinjo seed (91% by weight), dextrin (9% by weight)

Resveratrol content: 20% by weight or more (HPLC)

Grain size: 22 mesh

(3) Polygonum cuspidatum extract

“Resveratrol” (Product name) manufactured by Everyday Wellness Corporation (USA)

Material: Polygonum cuspidatum (natural Polygonum Cuspidatum)

Powder type

(4) Garlic: white species, Fukuoka Prefecture-grown

(5) Egg yolk: extracted from chicken eggs

(6) Edible oil: rice bran oil

### Production Example 1

The outer skin of raw garlic was peeled, and 10000 g of bulbs were ground and blended with 2000 g of egg yolk. The obtained mixture was sufficiently stirred to obtain a prepared material. Next, the prepared material was moved to a heater and heated with the temperature adjusted to 70° C. or less. Water was evaporated with the stirring speed adjusted to prevent burning. In this step, the color of prepared material was gradually changed to brown, and simultaneously its viscosity started increasing. After about 6 hours, the whole prepared material consisting of garlic and egg yolk became the clay state to form a clayey composition (brown).

Next, to 240 g of this clayey composition, 20 g of grape extract was added and the obtained mixture was sufficiently kneaded to obtain a garlic egg yolk composition in Production Example 1.

The garlic egg yolk composition in Production Example 1 had a pale purple color and smell thereof had a flavor like wine or unrefined sake. Garlic odor thereof clearly decreased as compared to that before the addition of grape extract. Compared to the prepared material before the addition of grape extract, similar stimulation as one when eating garlic drastically decreased. In the production step, as water decreased, both of the garlic odor and the flavor like wine or unrefined sake were faded. Finally, at the time of completion of drying, the garlic odor was removed to a level at which the odor was hardly smelled. An acridity of taste peculiar to garlic was not felt either.

### Production Example 2

A clayey composition consisting of heated garlic and egg yolk was obtained by the same method as in Production Example 1. To 240 g of this clayey composition, 20 g of melinjo extract was added and the obtained mixture was sufficiently kneaded to obtain a garlic egg yolk composition in Production Example 2.

The garlic egg yolk composition in Production Example 2 had a milk white color and sweet smell like dairy products was emitted at the moment when being kneaded. Garlic odor thereof was drastically suppressed as compared to that before the addition of melinjo extract.

When eating the garlic egg yolk composition before drying, it hardly had similar stimulation as one when eating garlic and instead had a flavor like pastries of coconut milk.

Finally, at the time of completion of drying, the garlic odor was removed to a level at which the odor was hardly smelled. An acridity of taste peculiar to garlic was also hardly smelled.

### Production Example 3

The outer skin of raw garlic was peeled, and 10000 g of bulbs were ground and blended with 1500 g of egg yolk and 200 g of grape extract to produce a prepared material. Next, the prepared material was stirred with heating at 70° C. or less, and until the clay state was obtained, water was evaporated to obtain a garlic egg yolk composition (purplish brown) in Production Example 3.

In the stage of preparing a prepared material consisting of garlic, egg yolk and grape extract, garlic odor and flavor like wine coexisted, however, as water was evaporated and dough became closer to the clay state, both the garlic odor and the wine aroma were faded, and especially the deodorization effect on the garlic odor was noticeable.

### Production Example 4

The outer skin of raw garlic was peeled, and 10000 g of bulbs were ground and blended with 1500 g of egg yolk and 200 g of grape extract, and the obtained prepared material was stirred with heating at 70° C. or less. At the time at which the prepared material became a looser paste than that in Production Example 3, 200 g of grape extract was blended therewith. The obtained mixture was stirred with heating at 70° C. or less, and until the clay state was obtained, water was evaporated to obtain a garlic egg yolk composition (purplish brown) in Production Example 4.

In the stage of preparing a prepared material consisting of garlic and egg yolk, garlic odor existed, however, as the dough became closer to the clay state by evaporating water, adding grape extract thereto and heating the obtained mixture, both the garlic odor and wine aroma were faded, and especially the deodorization effect on the garlic odor was noticeable.

### Production Example 5

A garlic egg yolk composition (whitish brown) in Production Example 5 was obtained in the same manner as in Production Example 3 except that 200 g of melinjo peel extract was used in place of 200 g of grape extract.

### Production Example 6

A garlic egg yolk composition (whitish brown) in Production Example 6 was obtained in the same manner as in Production Example 4 except that 200 g of melinjo peel extract was used in place of 200 g of grape extract.

In both Production Examples 5 and 6, the deodorization effects on garlic odor immediately after mixing melinjo peel extract are noticeable as compared to that of grape extract.

As water was evaporated and dough became closer to the clay state, the garlic odor was further deodorized, and the garlic odor is hardly emitted after drying.

### Production Example 7

A clayey composition consisting of garlic and egg yolk was obtained by the same method as in Production Example 1. In 50 g of edible oil, 50 g of this clayey composition was dissolved, and 10 g of grape extract was blended therewith to obtain a garlic egg yolk composition in Production Example 7.

Although garlic odor and similar smell as one when wine brewing existed at the beginning of the production step, both odors were suppressed over time and were drastically reduced after a night and day.

### Production Example 8

A garlic egg yolk composition in Production Example 8 was obtained in the same manner as in Production Example 7 except that 10 g of melinjo extract was used in place of 10 g of grape extract. Unlike the case of Production Example 7, most of the garlic odor disappeared at the moment when melinjo extract was blended.

### Production Example 9

In 50 g of edible oil, 50 g of grated garlic and 5 g of crushed egg yolk were dissolved, and homogenously mixed. Next, a garlic egg yolk composition in Production Example 9 was obtained by blending the edible oil, in which garlic and egg yolk were dispersed, with 10 g of grape extract.

Although garlic odor and similar smell as one when wine brewing existed at the beginning of the production step, both odors were suppressed over time and were drastically reduced after a night and day.

### Production Example 10

A garlic egg yolk composition in Production Example 10 was obtained in the same manner as in Production Example 9 except that 10 g of melinjo extract was used in place of 10 g of grape extract. Unlike the case of Production Example 7, most of the garlic odor disappeared at the moment when melinjo extract was blended.

### Production Example 11

A clayey composition consisting of heated garlic and egg yolk was obtained by the same method as in Production Example 1.

To 240 g of this clayey composition, 30 g of Polygonum cuspidatum extract was added and the obtained mixture was sufficiently kneaded to obtain a garlic egg yolk composition in Production Example 11.

Herbal medicine-like odor was emitted at the moment when the garlic egg yolk composition in Production Example 11 was kneaded, and it was not felt that garlic odor was much reduced. As drying proceeded, however, the color was changed to dark brown, and the herbal medicine-like odor and simultaneously the garlic odor were largely reduced.

Finally, at the time of completion of drying, the color of the garlic egg yolk composition in Production Example 11 was changed to dark brown, and the garlic odor was removed to a level at which the odor was hardly smelled. The taste was milder and less acrid than that of a conventional garlic egg yolk composition not containing Polygonum cuspidatum extract.

### Production Example 12

The outer skin of raw garlic was peeled, and 1000 g of bulbs were ground and blended with 150 g of egg yolk to produce a prepared material. Next, the prepared material was stirred with heating at 70° C. or less, and water was evaporated until a loose paste was obtained, and 30 g of powdered Polygonum cuspidatum extract was then added thereto and the obtained mixture was heated (70° C. or less). Until the clay state was obtained, water was evaporated to obtain a garlic egg yolk composition (dark brown) in Production Example 12.

As garlic and egg yolk were heated, garlic odor became strong, however, as by adding Polygonum cuspidatum extract thereto and further heating the obtained mixture, dough became closer to the clay state, both the garlic odor and the herbal medicine-like odor were faded. Especially, the deodorization effect on the garlic odor was noticeable.

### Production Example 13

In 50 g of edible oil, 50 g of grated garlic and 5 g of crushed egg yolk were dissolved, and this was homogenously mixed. Next, a garlic egg yolk composition in Production Example 13 was obtained by blending the edible oil, in which garlic and egg yolk were dispersed, with 15 g of Polygonum cuspidatum extract.

Although garlic odor and herbal medicine-like odor existed at the beginning of the production step, both odors were drastically reduced by leaving the composition to stand for 3 days.

“Confirmation of the effect of promoting blood circulation”

(Test 1)

After 20 test subjects took 1 g of the composition in Production Example 1, a survey on the effect of promoting blood circulation was carried out.

The effect of promoting blood circulation was decided using the following criteria.

Existence of the effect of promoting blood circulation: increase in body temperature was clearly felt.

No effect of promoting blood circulation: increase in body temperature was not felt.

Among 20 test subjects taking the composition in Production Example 1, 6 test subjects answered that the composition had the effect of promoting blood circulation. Among subjects, no one had a heavy feeling in the stomach by tasting.

(Test 2)

A survey on the effect of promoting blood circulation was carried out in the same manner as in Test 1 except that the composition in Production Example 2 was used in place of the composition in Production Example 1. As a result, among 20 test subjects, 8 test subjects answered that the composition had the effect of promoting blood circulation. Among subjects, no one had a heavy feeling in the stomach by tasting.

(Test 3)

A survey on the effect of promoting blood circulation was carried out in the same manner as in Test 1 except that the composition in Production Example 11 was used in place of the composition in Production Example 1. As a result, among 20 test subjects, 5 test subjects answered that the composition had the effect of promoting blood circulation.

(Test 4)

A survey on the effect of promoting blood circulation was carried out in the same manner as in Test 1 except that the composition in Production Example 12 was used in place of the composition in Production Example 1. As a result, among 20 test subjects, 4 test subjects answered that the composition had the effect of promoting blood circulation. No one had a heavy feeling in the stomach after eating.

(Test 5)

A survey on the effect of promoting blood circulation was carried out in the same manner as in Test 1 except that the composition in Production Example 13 was used in place of the composition in Production Example 1. As a result, among 20 test subjects, one test subject answered that the composition had the effect of promoting blood circulation. No one had a heavy feeling in the stomach after eating.

As a comparative test, after 20 test subjects took 1 g of a composition in Comparative Examples 1 to 3 described below and the composition in Production Example 1, a survey on the effect of promoting blood circulation was carried out.

### Comparative Example 1

### A Composition in Which 10 g of a Clayey Composition Consisting of Garlic and Egg Yolk Obtained by the Method in Production Example 1 was Dissolved in 50 g of Edible Oil

### Comparative Example 2

### A Composition in Which 10 g of Garlic Extract and 1 g of Egg Yolk Extract Were Dissolved in 50 g of Edible Oil

### Comparative Example 3

### A Composition in Which 10 g of Garlic Extract was Dissolved in 50 g of Edible Oil

When 20 subjects took 1 g of each composition in Comparative Examples 1 to 3, 4 subjects had a heavy feeling in the stomach after tasting.

### INDUSTRIAL APPLICABILITY

According to the present invention, a garlic egg yolk composition in which the smell derived from garlic is suppressed and can be obtained without using a special production device, chemicals, chemical additives and the like. The garlic egg yolk composition can be used as a health food, a dietary supplement, a nutritional supplement and the like.

1-8. (canceled)

9. A garlic egg yolk composition, comprising a resveratrol-containing plant extract and garlic and egg yolk, wherein the resveratrol-containing plant extract is selected from grape extract, melinjo extract and Polygonum Cuspidatum extract.

10. The garlic egg yolk composition according to claim 9, containing from 10 parts by weight to 100 parts by weight inclusive of the plant extract relative to a total of 100 parts by weight of garlic and egg yolk.

11. The garlic egg yolk composition according to claim 9, wherein the garlic and egg yolk are subjected to heat treatment.

12. The garlic egg yolk composition according to claim 10 wherein the garlic and egg yolk are subjected to heat treatment.
